(19) United States
(12) Patent Application Publication
(10) Pub. No.: US 2007/0162842 A1
(43) Pub. Date: Jul. 12, 2007

(54) Selective content imaging for web pages

(75) Inventors: Mark Ashley Ambachtsheer, Vancouver (CA); Richard Cave, Camas, WA (US); Darryl Will Fuller, Burnaby (CA); Philip Andrew Mansfield, Vancouver (CA)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/329,344

(22) Filed: Jan. 9, 2006

(51) Int. Cl. G06F 17/00

(52) U.S. Cl. 715/513

(57) ABSTRACT

Selective imaging of webpage content is disclosed. It is determined automatically whether an item of content or a portion thereof satisfies one or more of a set of one or more criteria to be included as an image in a webpage as published. An image of the item of content is generated and included in the webpage as published if it is determined that the item of content satisfies one or more of the set of one or more criteria.

### BACKGROUND OF THE INVENTION

Widely supported Web page formats (including HTML, CSS, ECMAScript and bitmap image formats GIF, JPEG and PNG) are limited in terms of the content and styling they can represent. For example, many high-end design features common in magazines and other professionally published content are not directly representable in widely-supported Web formats. Until now, Web authors have dealt with these limitations in the following ways:

1. Limiting the content and styling to that which can be directly represented on a Web page, with inferior results. Normal Web authoring tools have this limitation built in.

2. Creating a bitmap image of parts of the content that cannot be directly represented using widely-supported Web formats (these images being an indirect representation), and cleverly distributing these images on the page to create the appearance of more sophisticated styling and content.

The second approach requires a high level of expertise in terms of understanding the technical limitations of Web formats and understanding how to mix images with HTML, CSS, and ECMAScript in order to achieve the desired effect. Therefore high-end Web publishing is inaccessible to a great many authors or would-be authors of Web pages.

It is not feasible to image a whole Web page, since this would greatly increase the space needed to store each page and the bandwidth required to download each Web page within a reasonable period of time. It would also make the content much less accessible and harder to search or hyperlink, while restricting the ability to adapt the renderings to Browser window size, device, user preferences, etc. Therefore a hybrid content imaging solution is needed to create effective and attractive Web pages.

The limitations on Web publishing arise from many sources, including but not limited to: CSS shortcomings; HTML shortcomings; browser differences; operating system differences; installation/configuration dependencies e.g. fonts or browser plug-ins; and hardware differences and/or limitations, e.g., PDA/cell phone limitations.

The determination of the exact situations that require imaging is a difficult and specialized skill because it involves understanding complex combinations of the above limitations. Therefore, there is a need for a way to enable a relatively unsophisticated user to create a web page in which selective content is imaged automatically based on the limitations of the languages, formats, and protocols used to encode and publish the web page.

### BRIEF DESCRIPTION OF THE DRAWINGS

Various embodiments of the invention are disclosed in the following detailed description and the accompanying drawings.

FIG. 1 is a block diagram illustrating an embodiment of a user interface for creating and/or editing a webpage.

FIG. 2 is a flow chart illustrating an embodiment of a process for enabling a user to create and/or edit a webpage.

FIG. 3 is a flow chart illustrating an embodiment of a process for providing a webpage creation/editing interface.

FIG. 4 is a flow chart illustrating an embodiment of a process for automatically selectively imaging webpage content.

FIG. 5 is a flow chart illustrating an embodiment of a process for identifying automatically webpage content required to be imaged.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Selective content imaging for web pages is disclosed. In some embodiments, webpage content that is required to be imaged to be represented as desired on the webpage as published is identified automatically. The identified content is imaged and automatically integrated with directly represented content when publishing to the Web. In some embodiments, a webpage or other authoring and/or publishing application used to create and/or edit the webpage is configured to automatically identify the content required to be imaged, generated the images, and stitch the imaged content together with the directly represented content. In some embodiments, a native file format of the application that encodes a full high-end publishing representation that is distinct from and richer than the published format is used, thereby enabling further editing of the webpage content and, if needed, further identification and/or imaging of added and/or changed items.

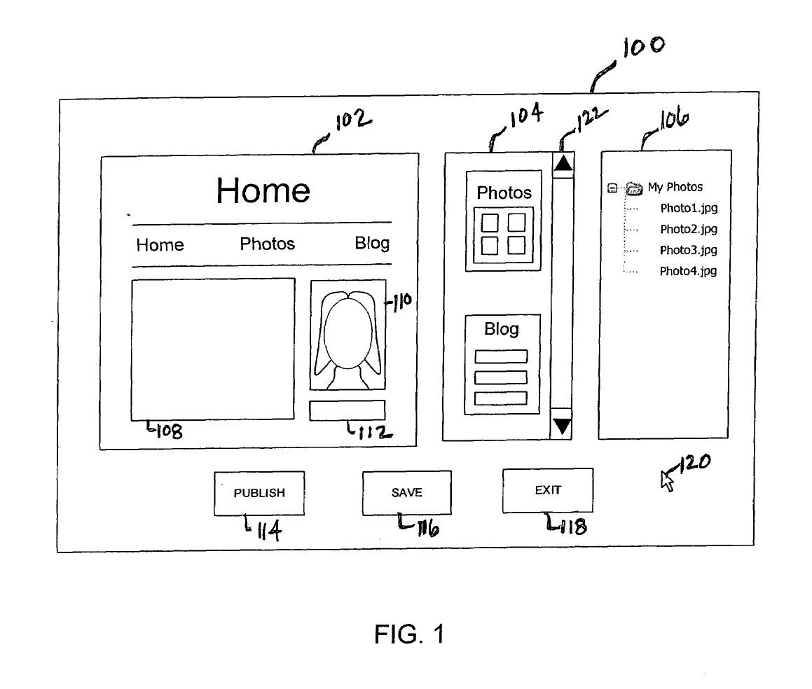

FIG. 1 is a block diagram illustrating an embodiment of a user interface for creating and/or editing a webpage. A user interface 100 includes an editing pane 102, a template pane 104, and a user file navigation pane 106. In some embodiments, the user file navigation pane 106 is not included in user interface 100 and is instead provided by an operating system or other software installed on a client on which the user interface 100 is running. The user file navigation pane 106 enables a user to navigate to user files stored on or otherwise available via the user's client system, such as files stored on a hard drive associated with the client system, on removable or other media currently installed on a drive or port of the client system, and/or on a system and/or storage device or media accessible to the client system via a network.

The user interface 100 also includes a “save” button 116 to save the webpage/project currently being edited, a “publish” button 114 to publish the current project to the Web, and an “exit” button 118 to exit the user interface 100 and close the associated application. A pointer icon 120 responsive to manipulation by a user of a mouse or other user input/control is provided to enable a user to activate controls such buttons 1 14-118, position a cursor in a text or other area, and/or drag/drop items into editing pane 102, such as a template from template pane 104 or a file or other object from user file navigation pane 106. Selection of the publish button 1 14 causes an application or module associated with user interface 100 to generate HTML and/or other code and objects as required to publish the webpage(s) to the Web. In some embodiments, selection of publish button 114 causes an existing or available web access and/or publishing account, such as “.Mac” account provide by Apple Computer, Inc., to be opened and used to publish the webpage(s). In some embodiments, if no such account exists or is known a user is prompted to open an account and/or provide data identifying an account to be used to publish the webpage(s).

In the example shown in FIG. 1, a home page has been selected for creation or editing. A home page such as the one displaying in the editing pane 102 as shown in FIG. 1 is opened in various embodiments by opening a previously saved webpage/website project that includes the home page, by selecting “new” from a file or other menu to indicate a desire to start a new webpage/website project, and/or by selecting a homepage template from among one or more homepage templates displayed in template pane 104.

Template pane 104 displays a “thumbnail” size icon for each of a set of one or more templates available to be selected by a user, e.g., by clicking or double-clicking on the desired template and/or dragging and dropping the desired template into editing pane 102, to create and open for editing in editing pane 102 a new webpage. In some embodiments, the templates displayed at any given time in template pane 104 comprise or at a user's option may comprise a subset of a broader set of available templates. In some embodiments additional templates may be obtained, e.g., purchased, via the Internet or otherwise. In some embodiments, the templates displayed in template pane 104 includes a blank template and/or one or more templates that have a background associated with one or more other templates displayed in template pane 104 but no other default/placeholder content. In the example shown, template pane 104 includes a scroll bar 122 to enable a user to view additional templates.

In various embodiments, templates as displayed in template pane 104 and/or as displayed initially in editing pane 102, when selected, include one or more items of placeholder content displayed as it would appear upon being published to the Web. The placeholder content enables a user to see the layout and styling applied to content items on the page. Placeholder text is replaced in some embodiments by selecting the placeholder text in the editing pane 102 and replacing it with user content, e.g., text entered in editing pane 102 using a keyboard or other input device; text cut and pasted from a document, file, clipboard, or other source; and/or text in a file or other object dragged from user file navigation pane 106 to the placeholder as displayed in editing pane 102.

In the example shown in FIG. 1, the home page displayed in editing pane 102 includes a placeholder title “Home” with a website navigation bar underneath the title listing the pages “Home”, “Photos”, and “Blog”. In this example, the project being edited includes three pages, each still having the placeholder title in the title area. In some embodiments, editing the title in any individual page causes the link to that page as listed in the navigation bar to be updated to reflect the user-supplied title. In some embodiments, a user can edit the automatically-generated link by clicking on the associated text in the navigation bar as displayed on any page and entering the desired text. The home page displayed in editing pane 102 as shown in FIG. 1 includes a main text area 108, an image area 1 10, and an image caption text area 112. In this example, a default image of a person's head is included as a placeholder image in image area 110, enabling a user to see the styling/formatting that would be applied to a user image substituted for the placeholder image. A user image dragged from user file navigation pane 106, e.g., “Photo1.jpg” in the example shown, and dropped in image area 110 in some embodiments causes the placeholder image to be replaced by the user image, with the styling and formatting formerly applied to the placeholder image being applied to the user image automatically, and the user image being displayed, in place of the placeholder image, in image area 110 in real time, automatically and substantially immediately after the user image file is dropped in image area 10, with the same appearance as the image would have as published to the Web.

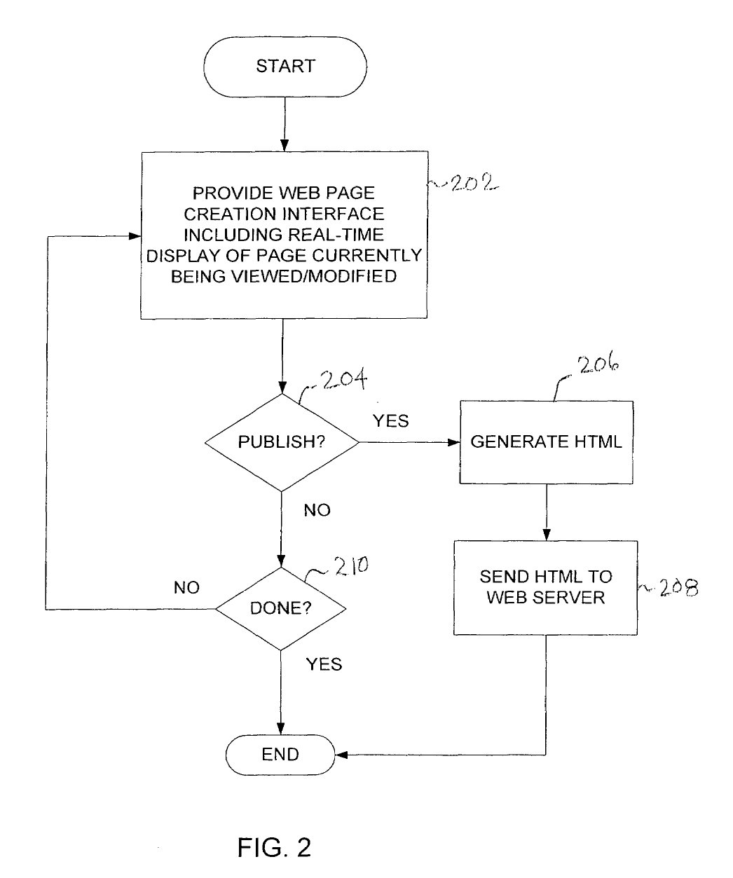

FIG. 2 is a flow chart illustrating an embodiment of a process for enabling a user to create and/or edit a webpage. In the example shown, at 202 a web page creation/editing user interface that provides in real time a display of a webpage that is currently being created, viewed, and/or edited that shows the webpage as it will/would appear when published to the Web. In some embodiments, the user interface 100 of FIG. 1 is provided. At 204, it is determined whether an indication has been received that the webpage and/or a website or project of which it is a component is desired to be published to the Web. If so, at 206 any HTML or other code or content required to be generated to publish the page (and any other pages comprising the site, if applicable) is generated and in 208 the HTML and/or other code or content is sent to a web server, after which the process of FIG. 2 ends. In some embodiments, 208 includes opening and accessing an existing, known (e.g., preconfigured), and/or newly opened web access and posting account, such as a .Mac account and providing the HTML and/or other code or content for publication to the Web. In some embodiments, 208 includes receiving a URL or other address or identifier usable to access the webpage and/or associated site via the Web. If at 204 it is determined that an indication that the webpage is to be published has not been received, it is determined at 210 whether the user has indicated he/she is done editing the current page or project. If so, the user interface is closed and the process of FIG. 2 ends. Otherwise, at 202 the interface remains open and the current page displayed unless/until the page is published and/or the user indicates he/she is done.

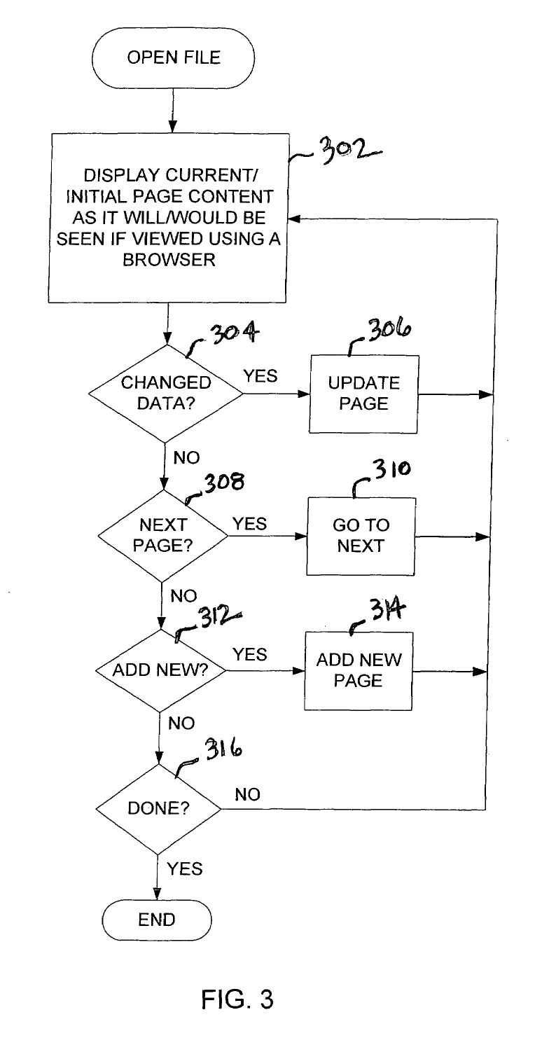

FIG. 3 is a flow chart illustrating an embodiment of a process for providing a webpage creation/editing interface. In some embodiments, 202 of FIG. 2 includes the process of FIG. 3. At 302, a webpage that is currently being created, viewed, and/or edited is displayed, e.g., in an editing pane such as editing pane 102 of FIG. 1, with current and/or initial or default page content with the appearance the page will/would have when/if published to the Web. As content data is added and/or modified (304) the display is updated automatically and in real time to incorporate the changes (306), so that the page as displayed via the user interface always shows the current state of the page as created and/or edited by the user, always having the appearance the page will/would have if/when published. If an indication that a next existing webpage, e.g., another page comprising a website or project with which a webpage currently being displayed is associated, is desired to be displayed and/or edited (308), the next page is accessed and displayed via the user interface (310) and the current page content for that page is displayed via the user interface, and updated as content is added and/or modified, as the user views/edits the page (302-306). If an indication that a new webpage, e.g., a new page to be added to a website or project with which a webpage currently being displayed is associated and/or a new page not related to the current page, is desired to be displayed and/or edited (312), the new page is generated, e.g., based on the selected template, and displayed via the user interface (314) and the current page content for that page is displayed via the user interface, and updated as content is added and/or modified, as the user views/edits the page (302-306). The process of FIG. 3 ends when an indication is received that the user is done creating/editing pages (316).

In some embodiments, prior to and/or at the time of publication, webpage content that is required to be imaged to be represented as desired on the webpage as published is identified automatically, and the identified content is imaged and automatically integrated with directly represented content when publishing to the Web.

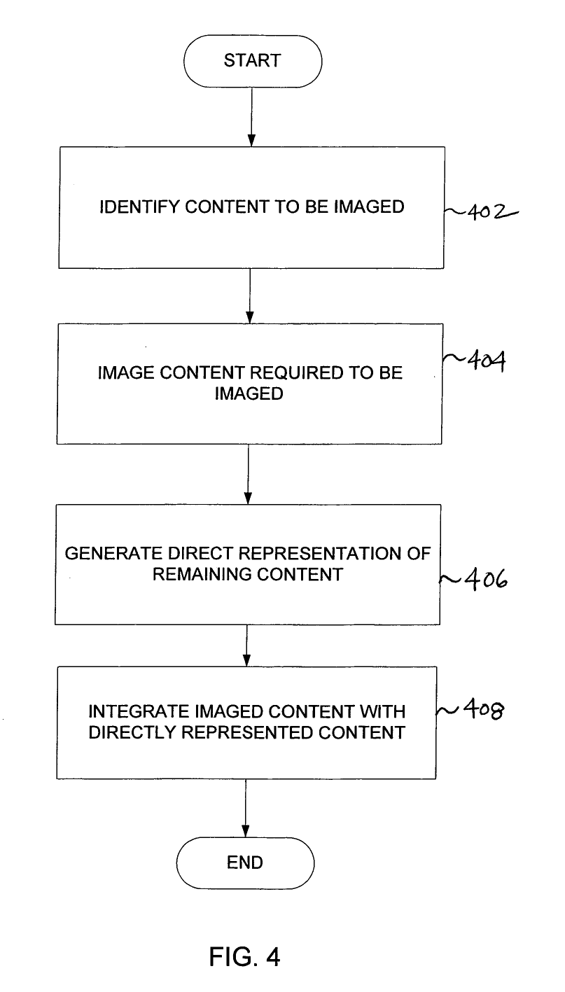

FIG. 4 is a flow chart illustrating an embodiment of a process for automatically selectively imaging webpage content. At 402, content to be imaged is identified. At 404, the content identified as being required to be imaged is imaged. At 406, a direct representation, e.g., encoding using HTML+CSS+ECMAScript, is generated for content not required to be imaged. At 408, imaged content is integrated with directly represented content, e.g., when the webpage is published to the Web. In various embodiments, one or more of 402, 404, 406, and/or 408 are performed with respect to items of content as they are created and/or added to a webpage, e.g., via an interface such as interface 100, and/or at the time of publication to the Web.

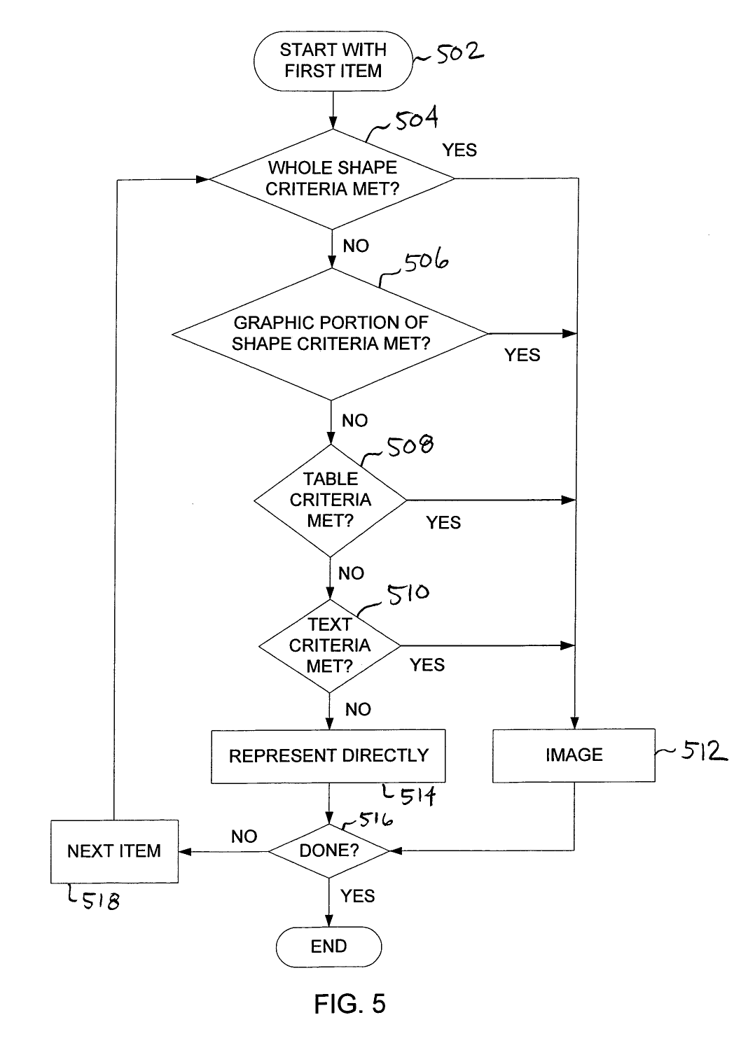

FIG. 5 is a flow chart illustrating an embodiment of a process for identifying automatically webpage content required to be imaged. In some embodiments, 402 of FIG. 4 includes the process of FIG. 5. The process of FIG. 5 starts with evaluation of a first item of content (502), which is evaluated to determine if it satisfies any applicable criteria for being included in the webpage as an image, rather than being represented directly, e.g., using HTML+CSS+ECMAScript. In the example shown in FIG. 5, criteria have been established, e.g., based on limitations of applicable encoding languages and/or standards, viewing software and/or equipment, etc., for determining whether a whole shape (504), graphic portions of a shape (506), a whole table (508), and/or text (510) should be imaged. In some embodiments, only the applicable ones of criteria 504-510 are applied to a given item of content; e.g., only criteria associated with 510 are applied to text. If any criterion for imaging is satisfied, the content is imaged (512); otherwise it is represented directly (514). In various embodiments, imaged content is included in the webpage as a JPEG and/or PNG and/or GIF and/or an image of another Browser-supported format. Processing of subsequent and/or remaining items of content continues (516 and 518) until all content has been classified, after which the process ends.

In some embodiments, at least one or more portions of a webpage are rendered using an embedded vector graphic rather than a raster graphic. In various embodiments, Macromedia Flash (including sIFR, or “Scalable Inman Flash Replacement” for rich Web typography), SVG, the <canvas> element that is part of the WHAT standard, and/or one or more other vector graphic formats are used. In some embodiments, vector graphic formats are used where interactivity, animation, or other features not available using raster graphic formats are desired. In some embodiments, vector graphic formats are used for at least some imaged content to take advantage the relatively small size of vector graphics (hence quick download times in Browsers) and the ability to have embedded font descriptions.

In some embodiments, dual technologies are used to achieve the same effect in different Browsers, for example, by using a first format to render an item of content as viewed by a first Browser and a second format for the same content as viewed by a second Browser. For instance, “opacity” is a proposed CSS3 property that is supported already by Firefox™ and Safari™, but not Microsoft Internet Explorer 6™. However, Microsoft Internet Explorer 6™ does have an “Alpha” filter property, which is Microsoft's proprietary animation/interactivity technology, which can in at least some circumstances be. In some embodiments, to render an item of content with opacity the Alpha filter is used for the page as viewed using Microsoft Internet Explorer 6™ and the “opacity” CSS3 property is used for other browsers. In some embodiments, JavaScript dynamically determines which of these options to use when someone goes to view the webpage, based on the Browser they are using. While rendering an item of content having opacity is used in the preceding examples, the dual technology approach may be used whenever two or more Browsers have different features or functionality for providing the same desired characteristic in content as rendered via the Browser, not just opacity.

In various embodiments, the criteria applied at 504 to determine whether a whole shape is to be imaged include one or more of the following: the shape is inserted inline (as opposed to floating or absolutely positioned) [HTML limitation]; there is a hyperlink on the shape itself (since <a> elements cannot contain <div> elements) [HTML limitation]; the shape is not rectangular [HTML limitation]; the shape has geometry that is not supported in HTML or CSS, such as flipping, either horizontal or vertical [CSS limitation], shear [CSS limitation], and/or rotation [CSS limitation]; the shadow of the shape is visible [CSS limitation]; the shape has overall transparency [CSS limitation]; and/or the shape is less than 32700 pixels in width and height (approximately the size limit of a TIFF image used for intermediate processing in some implementations), and its text content meets one or more criteria for imaging text.

In various embodiments, the criteria applied at 506 to determine whether graphical portions of a shape are to be imaged, e.g., by imaging the stroke and fill of a shape, but representing associated text as HTML/CSS text, include one or more of the following: the stroke of the shape is visible (e.g., in the case of an authoring application that generates shapes with strokes that are not exactly representable in HTML and CSS) [CSS limitation]; and/or the fill of the shape has one or more of the following properties: it uses a tiled image fill and the image has transparency [Microsoft Internet Explorer browser limitation], it uses a gradient fill [CSS limitation], or it uses a color fill, and the color has an alpha transparency component [CSS limitation].

In various embodiments, the criteria applied at 508 to determine whether a whole table is to be imaged include one or more of the following: there is a hyperlink on the table itself (since <a> elements cannot contain <table> elements) [HTML limitation]; one of the cells in the table has one of the following properties: the cell has an image or gradient background [CSS limitation], the cell contains text that should be imaged, and/or the table has an overall fill and the cell uses a vertical inset that works differently than an HTML vertical insets [HTML limitation/difference]; there is geometry on the table that cannot be expressed in CSS, like rotation or shear [CSS limitation]; the table has a visible shadow [CSS limitation]; and/or the table has an overall transparency setting [CSS limitation].

In various embodiments, the criteria applied at 510 to determine whether text is to be imaged include one or more of the following: it is vertically aligned “bottom” or “center” [HTML limitation]; it contains a character or paragraph style with one of the following properties: it specifies a font for which the alternate Windows-style font name or CSS generic font family is not known [OS Font System Limitation], it specifies double or triple underlining [CSS limitation], it specifies an underline color that is different from the color of the text [CSS limitation], it specifies double or triple strikethrough [CSS limitation], it specifies a strikethrough color that is different from the color of the text [CSS limitation], it specifies both underline and strikethrough [CSS limitation], it specifies the use of font outlining (the font glyphs are not filled) [CSS limitation], it specifies a text color that contains alpha transparency [CSS limitation], it specifies a text shadow with an overall alpha transparency [CSS limitation]; the text contains a table that should be imaged; its text content contains floating drawables that overlap [difference between certain authoring applications and HTML]; and/or the text box contains too much text to be displayed within the bounds of the box, causing an “overfull” indicator in the authoring application [difference between certain authoring applications and HTML].

In some embodiments a native file format that encodes a full high-end publishing representation of the content, e.g., a webpage, that is distinct from and richer than the published format is used. This enables further editing of the webpage content and, if needed, further identification and/or imaging of added and/or changed items prior to and/or at the time the edited webpage is published to the Web.

In certain of the examples described in detail above selective content is imaged rather than encoding that content as HTML+CSS+ECMAScript. However, the techniques described herein are applicable wherever formats, languages, and standards for encoding or otherwise directly representing content have limitations that require selective content to be included in a web page or the like as an image. As browsers, browser formats, browser plug-ins, operating systems, devices and authoring tools evolve, the specific situations requiring imaging of content will change. Regardless of the circumstances and/or limitations that require certain content to be imaged, a relatively unsophisticated user can be empowered to create and publish richly styled content by having those with the special and detailed knowledge of such limitations build that knowledge into an authoring application and/or associated tool usable to create and/or edit content, such as a webpage, by configuring the application or tool to identify automatically selective content that is required to and/or should be included as an image, rather than directly represented, to ensure proper appearance while not incurring the costs associated with excessive use of imaging.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for selective imaging webpage content, comprising:
determining automatically whether an item of content or a portion thereof satisfies one or more of a set of one or more criteria to be included as an image in a webpage as published; and
generating an image of the item of content and including the image in the webpage as published if it is determined that the item of content satisfies one or more of the set of one or more criteria.

2. A method as recited in claim 1, wherein the image of the item of content is generated and included in the webpage automatically if it is determined that the item of content satisfies one or more of the set of one or more criteria.

3. A method as recited in claim 1, wherein including the image in the webpage as published includes automatically stitching the image together with content represented directly using one or more webpage publishing formats.

4. A method as recited in claim 3, wherein the one or more webpage publishing formats include one or more of the following: HTML, CSS, ECMAScript, GIF, JPEG, and PNG.

5. A method as recited in claim 1, further comprising establishing the set of one or more criteria.

6. A method as recited in claim 1, wherein at least a subset of the set of one or more criteria comprise criteria based on at least one or more of the following: a limitation of CSS, HTML, ECMAScript, and/or some other Web format; a difference between a Web format and a webpage authoring application; a limitation of a browser; a difference between two or more browsers; a difference between two or more operating systems; a limitation of a hardware device; a difference between two or more hardware devices; an installation dependency; and/or a configuration dependency.

7. A method as recited in claim 1, further comprising storing content data associated with the webpage in a native file format associated with a webpage authoring application so that items of content determined to satisfy one or more criteria to be included as an image in the webpage as published can be modified in a native form, as opposed to by modifying a generated image of the item of content.

8. A method as recited in claim 7, further including receiving an indication that a previously-imaged item of content has been changed and re-imaging the item of content upon republishing the webpage.

9. A method as recited in claim 1, wherein the determination whether an item of content or a portion thereof satisfies one or more of a set of one or more criteria to be included as an image in a webpage as published is made when the item of content becomes associated with the webpage.

10. A method as recited in claim 1, wherein the determination whether an item of content or a portion thereof satisfies one or more of a set of one or more criteria to be included as an image in a webpage as published is made when the webpage is published.

11. A method as recited in claim 1, wherein if it is determined that the item of content satisfies one or more of the set of one or more criteria the image of the item of content is generated and included in the webpage when the webpage is published.

12. A method as recited in claim 1, wherein the set of one or more criteria includes one or more of the following criteria to determine when a whole shape is to be imaged: the shape is inserted inline (as opposed to floating or absolutely positioned); there is a hyperlink on the shape itself; the shape is not rectangular; the shape has geometry that is not supported in HTML or CSS, such as horizontal or vertical flipping, shear, and/or rotation; the shadow of the shape is visible; the shape has overall transparency; and/or the shape is less than 32700 pixels in width and height and its text content meets one or more criteria for imaging text.

13. A method as recited in claim 1, wherein the set of one or more criteria includes one or more of the following criteria to determine when a graphical portion of a shape is to be imaged: the stroke of the shape is visible and/or the fill of the shape has one or more of the following properties: it uses a tiled image fill and the image has transparency, it uses a gradient fill, and/or it uses a color fill, and the color has an alpha transparency component.

14. A method as recited in claim 1, wherein the set of one or more criteria includes one or more of the following criteria to determine when a whole table is to be imaged: there is a hyperlink on the table itself; one of the cells in the table has one of the following properties: the cell has an image or gradient background, the cell contains text that should be imaged, and/or the table has an overall fill and the cell uses a vertical inset that works differently than an HTML vertical insets; there is geometry on the table that cannot be expressed in CSS, like rotation or shear; the table has a visible shadow; and/or the table has an overall transparency setting.

15. A method as recited in claim 1, wherein the set of one or more criteria includes one or more of the following criteria to determine when text is to be imaged: it is vertically aligned “bottom” or “center”; it contains a character or paragraph style with one of the following properties: it specifies a font for which the alternate Windows-style font name or CSS generic font family is not known, it specifies double or triple underlining, it specifies an underline color that is different from the color of the text, it specifies double or triple strikethrough, it specifies a strikethrough color that is different from the color of the text, it specifies both underline and strikethrough, it specifies the use of font outlining, it specifies a text color that contains alpha transparency, it specifies a text shadow with an overall alpha transparency; the text contains a table that satisfies a criterion for imaging the table; its text content contains floating drawables that overlap; and/or the text box contains too much text to be displayed within the bounds of the box, causing an “overfull” indicator in the authoring application.

16. A method as recited in claim 1, further comprising representing the item of content directly using one or more webpage publishing formats if it is determined that the item of content does not satisfy one or more of the set of one or more criteria.

17. A method as recited in claim 1, wherein generating an image of the item of content comprises generating a vector graphic image of the item of content.

18. A method of encoding webpage content, comprising:
determining automatically that an item of content or a portion thereof is desired to have a visual effect as rendered that is to be achieved using a first encoding technique for viewing using a first set of one or more browsers and using a second encoding technique for viewing using a second set of one or more browsers; and
generating a first direct representation of the item of content using the first encoding technique and a second direct representation of the item of content using the second encoding technique;
and configuring a webpage comprising the item of content to provide for the item of content to a browser being used to view the webpage as published the first direct representation if the browser is included in the first set of one or more browsers and the second direct representation if the browser is included in the second set of one or more browsers.

19. A system for selectively imaging webpage content, comprising:
a processor configured to determine automatically whether an item of content or a portion thereof satisfies one or more of a set of one or more criteria to be included as an image in a webpage as published; and generate an image of the item of content and include the image in the webpage as published if it is determined that the item of content satisfies one or more of the set of one or more criteria; and
a memory coupled to the processor and configured to provide instructions to the processor.

20. A computer program product for selectively imaging webpage content, the computer program product being embodied in a computer readable medium and comprising computer instructions for:
determining automatically whether an item of content or a portion thereof satisfies one or more of a set of one or more criteria to be included as an image in a webpage as published; and
generating an image of the item of content and including the image in the webpage as published if it is determined that the item of content satisfies one or more of the set of one or more criteria.

21. A computer program product as recited in claim 18, further comprising computer instructions for storing content data associated with the webpage in a native file format so that items of content determined to satisfy one or more criteria to be included as an image in the webpage as published can be modified in a native form, as opposed to by modifying a generated image of the item of content.

22. A computer program product as recited in claim 18, further comprising computer instructions for representing the item of content directly using one or more webpage publishing formats if it is determined that the item of content does not satisfy one or more of the set of one or more criteria.
